(19) United States
(12) Patent Application Publication
(10) Pub. No.: US 2023/0280780 A1
(43) Pub. Date: Sep. 7, 2023

(54) AN ARBITRARY WAVEFORM GENERATOR WITH ADVANCED COMMAND CONTROL

(71) Applicant: ZURICH INSTRUMENTS AG, Zürich (CH)

(72) Inventors: Sebastian DÜTSCH, Zürich (CH); Niels HAANDBAEK, Zug (CH); Flavio HEER, Lufingen (CH)

(73) Assignee: ZURICH INSTRUMENTS AG, Zürich (CH)

(21) Appl. No.: 18/009,855

(22) PCT Filed: Jul. 1, 2020
(86) PCT No.: PCT/EP2020/068547

§ 371 Date: Dec. 12, 2022

(51) Int. Cl. G06F 1/03

(52) U.S. Cl. CPC G06F 1/0321

(57) ABSTRACT

An arbitrary waveform generator includes at least one analog output, a digital-to-analog converter connected to the analog output and a waveform source connected to the digital analog converter. The waveform source includes a waveform memory, a signal player and a signal processor. The waveform generator is controlled by a sequencer having an instruction memory for instructions and an instruction interpreter adapted to sequentially execute the instructions. A command table unit, in addition to the sequencer, is connected to the waveform source and includes a command table memory holding a plurality of commands. The commands include a waveform identifier for a waveform to be played and a parameter identifier describing how to modify the waveform in the signal processor. The sequencer can trigger the command table unit to execute a command therein, thereby playing the waveform with the parameter as identified by the command.

### TECHNICAL FIELD

The invention relates to an arbitrary waveform generator as well as to a method for operating such an arbitrary waveform generator.

### BACKGROUND ART

Arbitrary waveform generators (AWGs) are devices adapted to generate one or more arbitrary analog electric waveforms. They are e.g. used in quantum computing applications for applying control signals to a quantum processor or in device testing for applying probe signals to a device under test.

US2015277906A1 describes an arbitrary waveform generator having a control flow architecture that forms a sequencer for controlling it. Instructions in the control flow architecture are executed sequentially. They can e.g. be used to play a specific waveform stored in the memory of a waveform source.

### DISCLOSURE OF THE INVENTION

The problem to be solved by the present invention is to provide an AWG and a method for operating it that allows to quickly execute complex waveforms.

This problem is solved by the device and method of the independent claims.

Hence, in one aspect, the invention relates to arbitrary waveform generator comprising at least the following elements:
At least one analog output: This is the output carrying the signal generated by the AWG. The AWG may have several such outputs. The output may comprise additional analog circuitry elements, such as analog filter circuitry.
A digital-to-analog converter connected to analog output: This converter converts a digital series of numbers into the analog signal.
A waveform source connected to the digital-to-analog converter: The waveform source generates the digital series of numbers to be fed to the converter.
A sequencer: The sequencer is adapted to control the waveform generator. It has an instruction memory for instructions and an instruction interpreter adapted to sequentially execute these instructions. The instructions may e.g. include instructions for playing waveforms, for sampling signals, for looping, or branching, and for other purposes. They also include one or more types of “table execution instructions” as described in more detail below.
A command table unit: This is an element additional to the sequencer. It is connected to the waveform source and comprises a command table memory holding a plurality of commands. Each of these commands can be identified by means of a command address, such as the address of a memory cell in the command table memory. At least some of the commands comprise a waveform identifier descriptive of (i.e. uniquely identifying) a waveform to be played and/or a parameter identifier descriptive of (i.e. describing) a parameter for modifying the waveform to be played.

The sequencer is adapted to execute said “table execution instructions” (in addition to, potentially, other instructions, such as the branching and looping instructions mentioned above), with each table execution instruction specifying at least one command address. Upon execution of such a table execution instruction, the command table unit is triggered to cause the waveform source to play the waveform and apply the parameter as identified by the command(s) for the specified command address(es). The command address(es) may be provided directly as part of a table execution instruction, and/or a table execution instruction may specify to obtain the command address(es) form another source.

This design is based on the understanding that, in some cases, the sequencer instructions are advantageously not carried out directly, but rather they are used to identify commands in the command table, which are then applied to the hardware of the AWG. As explained below, this scheme can e.g. be used to compress several sequencer steps into a single one and/or to parametrize the operation of the AWG without changing the sequencer steps nor polling signals from the sequencer instructions explicitly.

In an advantageous embodiment, the “waveform source” of the AWG comprises at least the following elements:
A waveform memory: This is a memory area that holds a plurality of waveforms. A “desired” waveform in the waveform memory can be selected by the waveform identifier of the commands in the command table.
A signal processor structured to modify the desired waveform: This processor can be used to process the numerical signal of waveform before it is fed to the digital-to-analog converter. The signal processor can be controlled at least in part by the parameter identifier of the commands in the command table.

In this case, the desired waveform in the waveform memory (i.e. the waveform to be played) can be selected by means of the waveform identifier of the commands in the command table, and then it can be processed using the parameter identifier in the commands in the command table. This reduces the number of waveforms that have to be stored in the waveform memory.

The AWG may further comprise a waveform player generating a time series of numerical values from the selected waveform. In this case, the signal processor is advantageously arranged, at least in part, between the waveform player and the DAC, but it may also, at least in part, be implemented in the waveform player itself, or it may preprocess the selected waveform before it is fed to the waveform player.

The signal processor may comprise a scaler, which is typically implemented as a numerical multiplier, for scaling the selected waveform with a scaling factor. In this case, the parameter identifier of the commands in the command table can describe the scaling factor and/or a change of the scaling factor. This allows to specify, by means of the command table, a scaling factor to be applied to the waveform.

The signal processor may also comprise a mixer for mixing the selected waveform with a carrier signal. In this case, the parameter identifier of the commands in the command table can describe the phase and/or frequency of the carrier signal. This allows to specify, by means of the command table, the phase or frequency of the carrier signal. The carrier signal may e.g. be generated by a numerical oscillator.

The signal processor may also comprise a delay unit generating a delay in the selected waveform. In this case, the parameter identifier of the commands in the command table can describe a delay time to be applied by the delay unit. This delay time may be a delay in integer multiples of the rate of samples in the waveform generated by the waveform player. It may also be a general delay, in which case the delay unit advantageously comprises a resampler for resampling the waveform at interpolated values.

The signal processor may also comprise a filter for filtering the selected waveform. In this case, the parameter identifier of the commands in the command table can describe at least one parameter of this filter.

Advantageously, the command table unit comprises a write port for modifying the commands in said command table memory. This allows the user to modify the available commands and to adapt them to a specific application.

In this case, the sequencer may be connected to the write port and adapted to interpret “table change instructions” for writing commands into the command memory,

Alternatively or in addition thereto, the AWG may comprise an input interface for external signals. The input interface may in this case be connected to the write port for writing commands into the command memory without using the sequencer. This allows the user to e.g. load the commands directly into the command memory from an external source, such as from the user’s computer.

As mentioned, the command address may be stored directly in the program memory of the sequencer as part of a table execution instruction, and/or a table execution instruction may specify to obtain the command address from another source. For the latter case, the AWG may comprise a (e.g. serial or parallel) input interface for applying a multibit data word to the arbitrary waveform generator, and the sequencer is adapted to interpret at least one of the table execution instructions as an instruction to use this data word for generating the command address. This allows to change the specified command without modifying the instructions in the sequencer by simply changing the data word.

In another advantageous embodiment, at least some of the commands comprise a condition specifier. The command table unit is adapted to check for a given condition in the AWG as specified by the condition specifier and to execute said command only if the given condition is met. This allows to conditionally execute a command without using multiple instructions in the sequencer.

As mentioned, the invention also relates to a method for operating the arbitrary waveform generator as described herein. This method comprises at least the following steps:
Interpreting, in the sequencer, a “table execution instruction”: This means that, while interpreting the instructions in the sequencer, the sequencer encounters an instruction that is such a “table execution instruction”.
Identifying, using the table execution instruction, a command in the command table memory to be executed: In other words, the table execution instruction is examined as to which entry or entries in the command table it identifies.

As mentioned above, the table execution instruction may identify such a command explicitly, e.g. by its table address, or it may state how to derive the table address from other information available to the waveform generator.
Choosing a waveform to be played using the waveform identifier in the command to be executed: The command to be played is examined as to what waveform it specifies to be played.
Playing the waveform to be played and modifying it using the parameter identifier of the command to be executed: Hence, the command to be executed is not only used to specify the waveform to be played but also to specify how the waveform is to be modified.

In all embodiments of the invention, it must be noted that some of the commands in the command table may e.g. contain a waveform identifier only but no parameter identifier or vice versa. Or they may contain neither but may specify other operations to be executed by the arbitrary waveform generator, such as operations for setting, changing or querying counters.

As described below, the present arbitrary waveform generator is advantageously used for sending signals to a quantum processor.

### BRIEF DESCRIPTION OF THE DRAWINGS

The invention will be better understood and objects other than those set forth above will become apparent when consideration is given to the following detailed description thereof. Such description makes reference to the annexed drawings, wherein:

FIG. 1 shows a block circuit diagram of an AWG, and

FIG. 2 is a more detailed view of the command table unit.

### MODES FOR CARRYING OUT THE INVENTION

### Overview

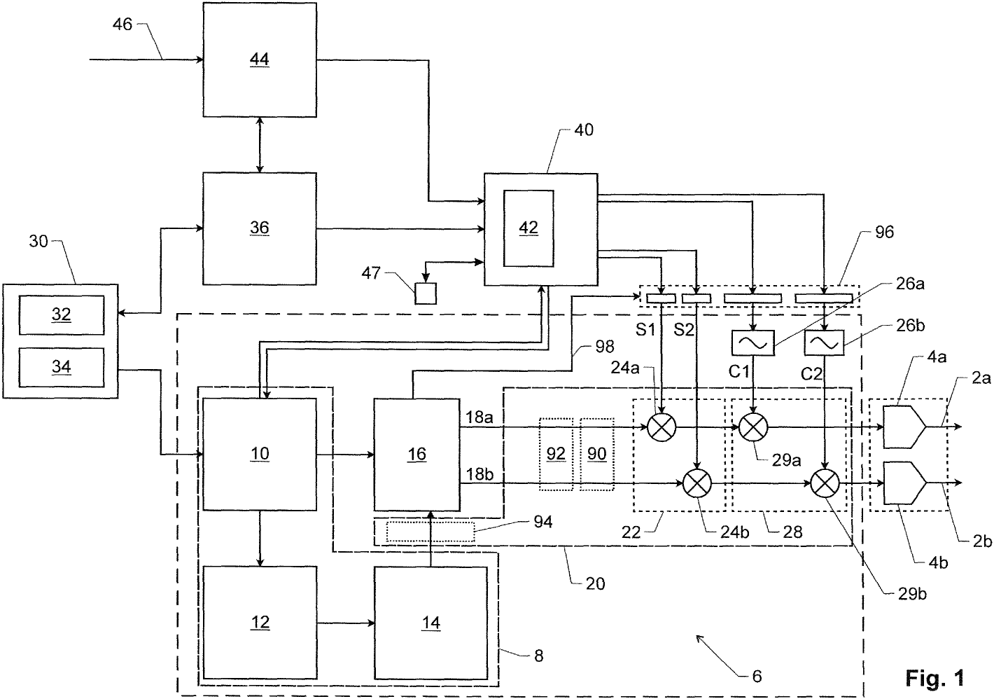

FIG. 1 shows some components of an AWG. In the present embodiment, the AWG has two analog outputs 2a, 2b, which can e.g. be the in-phase and quadrature components of a single signal. It must be noted, though, that the AWG may also have a single analog output only or more than two outputs.

The analog outputs 2a, 2b are generated by two digital-to-analog converters 4a, 4b. Optionally, there may be analog filters or other analog processing circuitry at the output side of the digital-to-analog converters 4a, 4b in order to filter and/or process the signals at the analog outputs 2a, 2b.

The input values for the digital-to-analog converters 4a, 4b are provided by a waveform source 6, which generates a series of numerical values to be fed to the converters.

Waveform source 6 may e.g. comprise a waveform memory 8, which stores data indicative of a plurality of different user-defined waveforms. For example, waveform memory 8 may store, for each or at least some of the waveforms, series of numbers of the values of the waveform at discrete time points.

For generating fast signals, waveform memory 8 advantageously comprises a caching mechanism including a cache manager 10, a main memory 12, and a cache memory 14, with main memory 12 having higher capacity but slower access than cache memory 14. When a given waveform is to be used, cache manager 10 is instructed to make it available in cache memory 14, if necessary, retrieving it from main memory 12.

The waveforms in waveform memory 8 can e.g. be identified by address or index and, if required, by its length.

Once a given waveform is selected and provided for playing, a waveform player 16 “plays” it, i.e. it generates values of the waveform at specific times, in particular at regular intervals. For example, waveform player 16 accesses the values in cache memory 14 (or, if timing allows, in another part of waveform memory 8), and makes them available, as a time series, at its outputs 18a, 18b.

Waveform source 6 further comprises a signal processor 20 for modifying the selected waveform. Signal processor 20 may comprise components between waveform player 16 and the digital-to-analog converter(s) 4a, 4b, but it may also comprise components arranged in the signal flow before waveform player 16 and/or components that are part of waveform player 16.

For example, signal processor 20 advantageously comprises a scaler 22 for scaling the selected waveform. Scaler 22 is advantageously arranged between waveform player 16 and digital-to-analog converter(s) 4a, 4b.

In the shown embodiment, scaler 22 comprises one or more multipliers 24a, 24b for multiplying values of the waveform with one or more scaling factors S1, S2.

In addition or alternatively thereto, signal processor 20 advantageously comprises one or more numerical oscillators 26a, 26b for generating one or more carrier signals C1, C2, which is/are fed to a mixer 28 for mixing the waveform with the carrier signal(s) C1, C2.

The carrier signal(s) is/are single frequency signals (such as a pure sine wave) with selectable frequency and/or phase and/or amplitude.

In the shown embodiment, the mixer 28 may comprise one or more multipliers 29a, 29b for multiplying values of the waveform(s) with the values of the carrier signals C1, C2.

The AWG further includes a sequencer 30 for controlling its operation.

Sequencer 30 comprises an instruction memory 32 for holding a series of instructions as well as an instruction interpreter 34 to interpret the instructions sequentially.

Sequencer 30 may cooperate with a load/store unit 36, which offers read-access and/or write-access ports to a variety of hardware signals and, optionally, storage locations within the AWG. These ports are addressable via port addresses that can be specified in the instructions stored in instruction memory 32.

It must be noted, though, that load/store unit 36 is an optional tool for providing an address-based programming model for the instructions in sequencer 30. Other means to access specific parts of the AWG by means of the instructions e.g. include providing dedicated instructions in the programming model for accessing these parts.

Sequencer 30 is typically adapted to execute various classes of instructions. These classes may e.g. include one or more of the following:
“Play-Wave instructions”: These instructions directly select a waveform in waveform memory 8 directly and have it played by means of waveform player 16 as it is known from conventional systems.
“Wave-Parameter instructions”: These instructions allow to set parameters of signal processor 20 (the respective data flow arrows are not shown in FIG. 1).
“Program-Flow instructions”: These instructions may e.g. include conditional or non-conditional branching instructions.
“Table execution instructions”: The function of these instructions is described in the following.
“Table change instructions”: The function of these instructions is described below.

The AWG further includes a command table unit 40. Command table unit 40 comprises a command table memory 42, which holds a plurality of commands. Each command can be identified by a command address, which may e.g. correspond to the memory location where the command is stored in command table memory 42.

As will be described in more detail below, each command comprises a waveform identifier descriptive of (i.e. identifying) a waveform to be played and a parameter identifier descriptive of (i.e. it allows to derive) a parameter for modifying the waveform. The waveform identifier can be fed to waveform memory 8 for selecting one of the waveforms therein. The parameter identifier may be used to generate at least one parameter for signal processor 20.

Each table execution instruction that is executed by sequencer 30 specifies a (i.e. at least one) command address in command table memory 42, either explicitly or indirectly, as described below. When the table execution instruction is executed, command table unit 40 is triggered to play the waveform with the parameter as identified by the command at the specified command address.

This will be described in more detail in the next section.

The AWG further comprises an input interface 44 connecting one or more external signals 46 to the AWG. The external signal(s) may include analog or digital signals (with any analog signals being converted to digital signals by means of one or more analog-to-digital converter(s)). The external signals may be fed serially or in parallel to the AWG.

At least some of the external signal(s) 46 may be queried by the instructions in sequencer 30, e.g. via load/store unit 36.

Other of the external signal(s) 46 may be used in connection with command table unit 40 as described in more detail in the next section.

### Command Table Unit

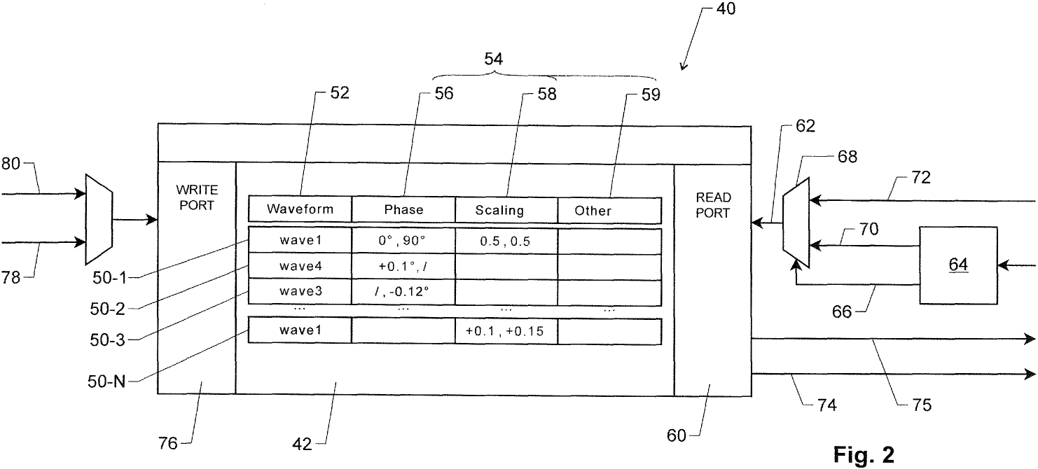

FIG. 2 shows a more detailed view of command table unit 40.

As mentioned, it comprises a command table memory 42 with locations 50-1 to 50-N for commands.

The number N of commands that can be stored in command table memory 42 is advantageously much larger than 1, e.g. at least 16, in particular at least 64, in particular at least 512.

In the shown embodiment, each command comprises the following entries:
A waveform specifier 52: The waveform specifier may e.g. comprise a multibit value (e.g. of 16 - 64 bit) indicative of the waveform, e.g. the address of a waveform to be specified in waveform memory 8 and, optionally, a multibit value specifying its length and/or other attributes, such as data indicative of the analog outputs it is to be played on. It may also comprise “enable information” indicating if the command is to trigger playing the specified waveform or not. This enable information may e.g. be encoded in a separate bit or as a “special” bit pattern (e.g. all 0) in the multibit value. The waveform in waveform memory 8 may contain a single time-series of values to be played, or it may e.g. contain two time-series of numbers representing the values at the outputs 18a, 18b of waveform player 16. In yet another example, waveform specifier 52 may specify the addresses of two separate waveforms in waveform memory 8, each of which specifies the time-series to be played at a respective one of the outputs 18a, 18b. For an AWG with N > 2 outputs, waveform specifier 52 may e.g. specify N waveforms, or it may specify a single waveform comprising a N time-series of values for the N outputs.
A parameter specifier 54: This specifies how the played waveform is to be modified. It is typically used to generate one or more parameters to be fed to signal processor 20. In particular, parameter specifier 54 may include at least one of the following:
   a) A phase specifier 56: This value specifies the phase of the carrier signal(s) C1, C2. Since, in the embodiment of FIG. 1, there are two such carrier signals, the shown embodiment of a command has room for two phase specifiers. The phase specifier(s) may e.g. comprise a multibit value (e.g. of 16 - 64 bit) indicative of the new phase or an increment/decrement of the present phase. It may also comprise “enable information”, e.g. in a flag bit, indicating if the command is to change the phase or not. It may also comprise “mode information”, e.g. in a mode bit, indicating if the multibit value is to be interpreted as a signed increment or an absolute value (with the former being added to the current phase and the latter replacing the current phase).
   b) A scaling specifier 58: This value specifies the scaling to be applied to the waveform in scaler 22. Since, in the embodiment of FIG. 1, there are two waveforms to scale, the shown embodiment of a command has room for two scaling specifiers. The scaling specifier(s) may e.g. comprise a multibit value (e.g. of 16 - 64 bit) indicative of how to change the scaling. It may also comprise “enable information”, e.g. in a flag bit, indicating if the command is to change the scaling or not. It may also comprise “mode information”, e.g. in a mode bit, indicating if the multibit value is to be interpreted as a signed increment or an absolute value (with the former being added to the current scaling and the latter replacing the current scaling).
Other 59: This entry (or several entries) may e.g. be one or more of the following:
   a) A frequency specifier: The command may, as part of parameter specifier 54, include a frequency specifier for frequency of the numerical oscillator(s) 26a, 26b. This specifier may again include “enable information” and “mode information” as in the example for the phase specifier above.
   b) A filter specifier: As described in more detail below, signal processor 20 may comprise a filter. In this case, the command may, as part of parameter specifier 54, include a filter specifier for controlling settings of the filter. This specifier may again include “enable information” and “mode information” as in the example for the phase specifier above.
   c) An interpolator specifier: As described in more detail below, signal processor 20 may comprise an interpolator. In this case, the command may, as part of parameter specifier 54, include an interpolator specifier for controlling settings of the interpolator. This specifier may again include “enable information” and “mode information” as in the example for the phase specifier above.
   d) A delay specifier: As described in more detail below, signal processor 20 may comprise a delay unit for delaying the waveform. In this case, the command may, as part of parameter specifier 54, include a delay specifier for controlling settings of the delay unit. This specifier may again include “enable information” and “mode information” as in the example for the phase specifier above.
   e) A condition specifier: Command table unit 40 may be adapted to check for a given condition specified by this condition specifier and to execute a command only if the given condition is met. This allows to conditionally execute a command without using multiple instructions in sequencer 30. For example, the condition specifier may identify one of the external signals 46 and indicate that the command is only to be executed if the identified external signal 46 has a given value.
   f) A counter operation specifier: The AWG may comprise at least one counter 47, and command table unit 40 may be adapted to access a value of counter 47 as a function of the counter operation identifier. For example, it may execute, as a function of the counter operation identifier, at least one of the following steps:
      Setting counter 47 to a specified value;
      Increasing or decreasing counter 47
      Querying the value of counter 47 and executing a command only if the value fulfils a certain condition. (This is similar to a condition specifier as mentioned above.)

The counter 47 may e.g. also be used count external signal pulses, and commands may e.g. be conditionally executed depending on the value of the counter.

Counter 47 may also be counting any event internal to the AWG.

As further shown in FIG. 2, command table unit 40 may include a read port 60 for reading a specified command 50 from command table memory 42 and executing it. The address 62 of the command to be read can be specified in at least one, or in both, of the following ways:
The address 62 may be received from sequencer 30 directly, i.e. the table execution instruction in sequencer 30 specifies the command in command table memory 42 explicitly, e.g. by its address. In the present embodiment, a table execution logic unit 64 is operated by the table execution instruction. A selector output 66 of table execution logic unit 64 specifies a multiplexer 68 to use the address 70 encoded in the table execution instruction.
The address 62 may be received from input interface 44, which e.g. has a multibit-input that can be interpreted as the address 72 of a command in command table memory 42. In this case, the table execution instruction in sequencer 30 causes table execution logic unit 64 to switch multiplexer 68 to use the address 72.

Once the address 62 has been specified, the selected command is advantageously read out in a single step, i.e. in the course of a single clock operation.

Read port 60 has at least two outputs. A waveform specifier output 74 carries the waveform specifier (or data derived therefrom) of the selected command and a parameter specifier output 75 carries the parameter specifier (or data derived therefrom) of the selected output.

As also shown in FIG. 2, command table unit 40 may include a write port 76 for writing commands into the locations in command table memory 42. Write port 76 receive data from one or more of the following sources:
Write port 76 may be connected (via an input 78) to sequencer 30. In this case, sequencer 30 is adapted to interpret “table change instructions” for writing commands into command memory 42. In this case, the user can specify new commands to be stored in command table memory 42 by means of one or more table change instructions in the program he loads into sequencer 30.
Write port 76 is connected to input interface 44 (via an input 80). In this case, the AWG is adapted to write commands from interface 44 directly into command memory 42 without using sequencer 30.

The present design allows the AWG to execute complex changes in its configuration with a single instruction from sequencer 30. For example, without command table unit 40, the following are the commands to be executed when playing several waveforms with different amplitudes and carrier phase:
1: play wave1
2: set phase sine gen 0
3: set phase sine gen 1
4: set amplitude 0
5: set amplitude 1
6: play wave2
7: set phase sine gen 0
8: set phase sine gen 1
9: play wave3

Instruction 1 plays the waveform wave1 with the presently set parameters of signal processor 20.

Instructions 2-5 prepare the amplitude and phase of the next waveform (wave2) while wave1 is being played.

Instruction 6 plays wave2 with the new parameters.

Instructions 7 and 8 prepare the phase of yet another waveform (wave3) and instruction 9 plays it.

In contrast to this, with the present design, a command specifying wave2 and its phase and amplitude can be stored in location X of command table memory 42 and it can be invoked with a single table execution instruction of sequencer 30:

1: execute command X

Hence, this design saves memory in sequencer memory 32 and, more importantly, allows to change between different settings and processing parameters very quickly.

### Signal Processor

As mentioned above and as shown in FIG. 1, signal processor 20 may comprise a scaler 22 for scaling the waveform and/or a mixer 28 for mixing it with one or more carrier signals.

Signal processor 20 may, however, also comprise one or more other processing elements in addition or alternatively thereto, such as specified by reference numbers 90 - 94. These processing elements may be arranged at any suitable point along the signal path, and the locations shown in FIG. 1 are mere examples.

For example, signal processor 20 may comprise a filter 90. This filter filters the selected waveform that is to be played or is being played. It may e.g. have one or more of the following functions:

a) It may be adapted to apply a kernel to the selected waveform by means of a convolution operation. In this case, parameter identifier 54 is descriptive of the kernel.

b) It may be adapted to apply a window function to the selected waveform. In this case, parameter identifier 54 is descriptive of at least one window parameter of said window function.

c) It may be a clipping filter limiting the amplitude of the desired waveform. In this case, parameter identifier 54 is descriptive of a maximum amplitude to be passed by the clipping filter.

d) It may add, for each sample value of the wave signal, a zero value or a value of opposite sign, e.g. before or after the sample value. In this case, parameter identifier 54 may comprise bits indicating which one (if any) of these operations is to be enabled.

e) It may add a constant value/offset to the waveform.

Filter 90 may have at least one memory cell that changes its value during a filtering operation. In this case, parameter identifier 54 may describe if this memory cell is to be reset to a predefined value in order to bring the filter into a defined state.

In addition or alternatively thereto, signal processor 20 may comprise a delay unit 92 for delaying the waveform. In this case, the command may, as part of parameter specifier 54, include a delay specifier for controlling settings of delay unit 92 as mentioned above.

Delay unit 92 may generate a delay in integer multiples of the rate of samples in the waveform. It may also generate a general delay, in which case delay unit 92 advantageously comprises a resampler for resampling the waveform at interpolated values.

In the example of FIG. 1, delay unit 92 is located between waveform player 16 and scaler 22. However, it may e.g. be arranged earlier or later in the signal path, even between mixer 28 and the digital-to-analog converters 2a, 2b.

In addition or alternatively thereto, signal processor 20 may also comprise an interpolator 94 (which is, by way of examples, shown as being located between waveform memory 8 and waveform player 16, but it may also be located after waveform player 16). Interpolator 94 can interpolate the selected waveform at times outside the data points stored in waveform memory 8. In this case, the parameter identifier is descriptive of at least one parameter of interpolator 94, such as the number of interpolation points between the data points of the waveform.

FIG. 1 shows yet another aspect of signal processor 20. Namely, the AWG may comprise a parameter buffer 96. It buffers the parameter identifier (either directly or as a value derived therefrom) before it is fed to signal processor 20. It may e.g. be implemented as a register or latch.

Waveform player 16 is adapted to trigger parameter buffer 96, by means of a trigger signal 98, to forward the parameter identifier of a given command to signal processor 20 when waveform player 16 starts playing the waveform identified by the waveform identifier of the same command, thereby aligning the start of the waveform with feeding the new parameter settings to signal processor 20.

### Applications

An important application of the present AWG is the control of a quantum processor, in particular the execution of “gate operations” in such a quantum processor.

The elementary operation in a quantum processor is called a gate operation. Examples are so-called X-gates, Y-gates or H-gates. Each gate operation is a combination of specific RF pulses, oscillator phase changes and amplitudes on one or more outputs of the AWG.

In this case, command table memory 42 may contain definitions of gate operations for the quantum processor such that a quantum program can be specified by referring to entries of the command table memory 42. This application-specific abstraction greatly reduces the size and complexity of a program for a quantum computer and increases the performance compared to general-purpose control systems.

For example, once a library of gates consisting of a waveform tables and command tables is available, an update of the sequences of references to command table memory 42 is sufficient to execute a different program on a quantum computer.

Another important application in context of a quantum processor lies in randomized benchmarking.

Command table memory 42 also allows for the real-time generation of gate sequences, for example to realize “randomized benchmarking”. A pseudo-random number generator is used to refer to random gate operations defined in the command table.

The present device can also be advantageously used for qubit-spectroscopy where the same waveform has to be repeatedly with a number of different amplitudes.

### Notes

Even though the components of the AWG may be formed with any suitable technology, command table unit 40, sequencer 30, and at least parts of waveform source 6 are advantageously formed from an FPGA for fast execution, highly parallel operation, and easy redesign.

The various signal paths, e.g. between sequencer 30 and command table unit 40 or between cache manager 10 and waveform player 16, may include command queues to allow an asynchronous operation of the components.

As mentioned, the AWG may e.g. have one or two analog outputs. It may, however, also have even more analog outputs. In particular, it may have several independent output channels, each with its own waveform source and signal processor.

The two outputs 2a, 2b may, as mentioned, be the in-phase and quadrature components of a single signal, and they may be added in an analog adder. In yet another embodiment, the two signals from mixer 28 may be added to each other digitally before being fed to a single digital-to-analog converter.

In the embodiment of FIG. 1, mixer 28 is a digital mixer, i.e. it is arranged before the digital-to-analog converter(s) 4a, 4b. It may mix the waveform with the final carrier signal, or it may mix them with an intermediate carrier signal, which subsequently may e.g. be up and down converted to a desired carrier frequency in the analog domain.

Mixer 28 may also be implemented after the digital-to-analog converter(s) 2a, 2b as analog circuitry.

As described above, using a command table unit allows reducing the size of a sequencer program. A single instruction may trigger a play-command, a phase change, and an amplitude change at the same time. This can be extended easily to support additional signal conditioning functions or other functions to control the AWG.

Another advantage is that the total size and/or number of waveforms can be reduced. If a waveform is required in several scaled versions or modulated with different phase, the waveform may exist only once in waveform memory 8, and its scaling and modulation can be specified at playtime.

While there are shown and described presently preferred embodiments of the invention, it is to be distinctly understood that the invention is not limited thereto but may be otherwise variously embodied and practiced within the scope of the following claims.

1. An arbitrary waveform generator comprising
at least one analog output,
a digital-to-analog converter connected to the analog output,
a waveform source connected to said digital-to-analog converter, and
a sequencer adapted to control the waveform generator, wherein said sequencer comprises an instruction memory for instructions and an instruction interpreter adapted to sequentially execute said instructions,
wherein said waveform generator further comprises a command table unit in addition to the sequencer, and wherein said command table unit is connected to the waveform source and comprises a command table memory holding a plurality of commands identifiable with command addresses, with at least some of said commands comprising a waveform identifier descriptive of a waveform to be played and/or a parameter identifier descriptive of a parameter for modifying said waveform,
wherein said sequenceris adapted to execute table execution instructions, with each table execution instruction specifying at least one command address, wherein, upon execution of such a table execution instruction, the command table unit is triggered to cause the waveform source to play the waveform with the parameter as identified by the command at the specified command address.

2. The arbitrary waveform generator of claim 1, wherein said waveform source comprises;
a waveform memory holding a plurality of waveforms, wherein a desired waveform in the waveform memory is selectable by the waveform identifier of the commands, and
a signal processor structured to modify the desired waveform, wherein said signal processor is at least partially controllable by the parameter identifier of the commands.

3. The arbitrary waveform generator of claim 2, further comprising a waveform player generating a time series of values from the selected waveform.

4. The arbitrary waveform generator of claim 3, further comprising a parameter buffer for buffering the parameter identifier, wherein said waveform player is adapted to trigger the parameter buffer to forward the parameter identifier of a given command to the signal processor in synchronization to starting playing a waveform identified by the waveform of the given command.

5. The arbitrary waveform generator of claim 2,wherein said signal processor comprises a scaler adapted to scale the selected waveform with a scaling factor, and wherein said parameter identifier is descriptive of said scaling factor and/or a change in said scaling factor.

6. The arbitrary waveform generator of claim 2, wherein said signal processor comprises a mixer for mixing the waveform of the waveform player with a carrier signal, and wherein said parameter identifier is descriptive of a phase and/or frequency of the carrier signal.

7. The arbitrary waveform generator of claim 2, wherein said signal processor comprises a delay unit generating a delay in the signal of the waveform player, wherein said parameter identifier is descriptive of a delay time to be applied by the delay unit.

8. The arbitrary waveform generator of claim 2, wherein said signal processor comprises a filter filtering the selected waveform, wherein said parameter identifier is descriptive of at least one parameter of said filter.

9. The arbitrary waveform generator of claim 2, wherein said signal processor comprises an interpolator for interpolating the selected waveform, wherein said parameter identifier is descriptive of at least one parameter of said interpolator.

10. The arbitrary waveform generator of claim 1,wherein said command table unit comprises a write port for modifying the commands in said command table memory.

11. The arbitrary waveform generator of claim 10, wherein said sequencer is connected to said write port and adapted to interpret table change instructions for writing commands into said command table memory.

12. The arbitrary waveform generator of claim 10, further comprising an input interface for external signals, wherein said input interface is connected to said write port for writing commands into said command table memory without using the sequencer.

13. The arbitrary waveform generator of claim 1, further comprising an input interface for applying a multibit data word to said arbitrary waveform generator, wherein the sequencer is adapted to interpret at least one of said table execution instructions as an instruction to use the data word for generating the command address.

14. The arbitrary waveform generator of claim 1, wherein at least some of said commands comprise a condition specifier, wherein said command table unit is adapted to check for a given condition specified by the condition specifier and to execute said command only if the given condition is met.

15. The arbitrary waveform generator of claim 1, further comprising at least one counter, wherein at least one of said commands comprises a counter operation identifier, wherein said command table unit is adapted to access a value of said counter as a function of said counter operation identifier.

16. A method for operating the arbitrary waveform generator of claim 1, further comprising:
interpreting, in said sequencer, a table execution instruction,
identifying, using said table execution instruction, a command in the command table memory to be executed,
choosing a waveform to be played using the waveform identifier in the command to be executed, and
playing the waveform to be played and modifying it using the parameter identifier of the command to be executed.

17. Use of the arbitrary waveform generator of claim 1 for sending signals to a quantum processor.

18. The arbitrary waveform generator of claim 8, wherein said filter is adapted to at least one of:
apply a kernel to the selected waveform by a convolution, wherein said parameter identifier is descriptive of said kernel,
apply a window function to the selected waveform, wherein said parameter identifier is descriptive of at least one window parameter of said window function, and
add, for each sample value of the selected waveform, a zero value or a value of opposite sign to the sample value.

19. The arbitrary waveform generator of claim 8, wherein said filter is a clipping filter limiting an amplitude of the selected waveform, wherein said parameter identifier is descriptive of a maximum amplitude to be passed by the clipping filter.

20. The arbitrary waveform generator of claim 8, wherein said filter has at least one memory cell that changes its value during a filtering operation, wherein said parameter identifier is descriptive of resetting said memory cell to a predefined value.

21. The arbitrary waveform generator of claim 14, further comprising an input interface for external signals, wherein said given condition depends on a signal at said input interface.

22. The arbitrary waveform generator of claim 15, wherein said command table unit is adapted to execute, as a function of said counter operation identifier, at least one of:
setting said counter to a specified value,
increasing or decreasing said counter, and
querying a value of said counter and executing a command only if the value fulfills a given condition.
